(19) United States
(12) Patent Application Publication
(10) Pub. No.: US 2026/0021380 A1
(43) Pub. Date: Jan. 22, 2026

(54) ARCADE-STYLE GAME INPUT DEVICE WITH USER-SWAPPABLE JOYSTICK GATES

(71) Applicant: Sony Interactive Entertainment Inc., Tokyo (JP)

(72) Inventors: Arthur Charles Kwun, San Mateo, CA (US); Kathleen Charles Balfour, San Mateo, CA (US); Alexander J. Brown, San Mateo, CA (US); Samuel Benjamin Schaevitz, San Mateo, CA (US); Ye Yen Scarlett Lai, San Mateo, CA (US); Ying Yan Guan, San Mateo, CA (US)

(21) Appl. No.: 18/776,802

(22) Filed: Jul. 18, 2024

(51) Int. Cl. A63F 13/24

(52) U.S. Cl. CPC A63F 13/24

(57) ABSTRACT

A wireless computer game controller has an arcade-style lever for controlling action in a computer game as well as action buttons reflecting contemporary game controllers and control buttons for controlling device operation. User-swappable gates are provided to limit motion of the lever.

### FIELD

The present application relates generally to arcade-style game input devices with user-swappable joystick gates.

### BACKGROUND

People who enjoy computer games using contemporary computer game controllers also enjoy an older arcade-style of game as well as so-called “fight” games. As understood herein, controlling such games given contemporary requirements of game developers requires a novel computer game controller.

### SUMMARY

As understood herein, to enhance the enjoyment of such games, a controller that reflects both contemporary computer game control principles but also mirrors features from retro arcade-style games and fight games is desirable.

Accordingly, an apparatus includes a base and plural active buttons arranged in two arcuate rows and juxtaposed with a top surface of the base. At least some of the active buttons can be manipulated to control a character in a computer game. Plural control buttons are supported by the base and are arranged in a single row, and at least some of the control buttons can be operable to input control signals to the apparatus. A lever extends through the base and is manipulable to input signals to the computer game. According to present principles, a first gate is below the top surface to limit pivotable motion of the lever in a first way, and at least a second gate is disposed in a cavity in the base and is swappable by hand with the first gate to limit pivotable motion of the lever in a second way.

In some embodiments the lever has a grip above the top surface of the base, and the grip is disposed on a top end of a shaft and extending radially beyond the shaft. The shaft extends through the top surface of the base. A portion of the shaft is disposed within a periphery of the first gate, and the periphery has a first shape. On the other hand, the second gate defines a periphery through which the shaft can extend when the second gate is swapped with the first gate, with the periphery of the second gate having a second shape.

The gate shapes can be, e.g., round, or square, or triangular, or octagonal, or hexagonal.

In example implementations a third gate is disposed in the cavity in the base and is swappable by hand with the first gate to limit pivotable motion of the lever in a third way.

In another aspect, a computer simulation controller (CSC) includes a base comprising a top surface and a lever extending through the base and manipulable to input signals to a computer game. The CSC also includes a first gate below the top surface at a location to limit pivotable motion of the lever in a first way. Further, the CSC includes at least a second gate disposed in a cavity in the base to limit pivotable motion of the lever in a second way when disposed in the location in lieu of the first gate.

In another aspect, a method includes providing a base, providing a movable lever extending through the base, and engaging a first motion limiter with the lever to limit motion of the lever in a first way. The method also includes providing in the base a second motion limiter to limit motion of the lever in a second way when the second motion limiter is used to replace the first motion limiter.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates a perspective view from above of a wireless peripheral controller for computer games;

FIG. 3 illustrates a perspective view from below of the controller in FIG. 1, with the bottom panel closure in the open configuration;

FIGS. 4-6 illustrate top views of example lever gates;

FIG. 7 illustrates a perspective view from above from a first edge of the controller in FIG. 1 illustrating the tilted active button pad;

FIG. 8 illustrates a side view from the first edge of the controller in FIGS. 1 and 7;

FIG. 9 illustrates a top plan view of the controller;

FIG. 10 illustrates example logic in example flow chart format related to the lock selector for disabling input from the control buttons of the controller while signals from the active buttons remain enabled;

FIG. 11 illustrates a perspective view of an example lever implementing digital input, showing only the portion of the controller immediately adjacent the level and with the top surface of the controller removed for clarity;

FIG. 12 illustrates a side cut-away view of the lever shown in FIG. 11;

FIG. 13 illustrates an exploded perspective view of the lever shown in FIG. 11;

FIG. 14 illustrates a perspective view of an example lever implementing analog input, showing only the portion of the controller immediately adjacent the level and with portions of the controller case removed for clarity;

FIG. 15 illustrates a side cut-away view of the lever shown in FIG. 14; and

FIG. 16 illustrates an exploded perspective view of the lever shown in FIG. 14.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

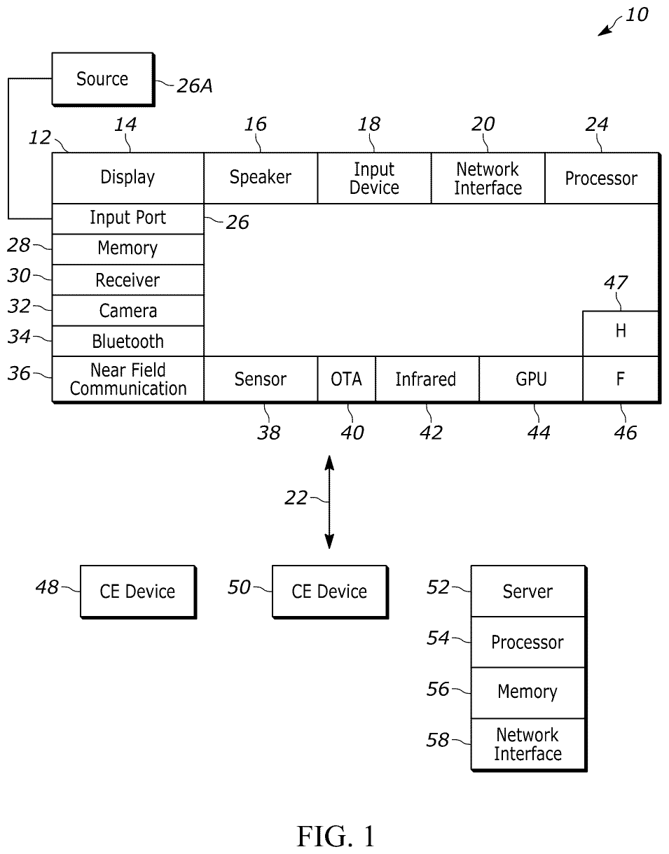

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

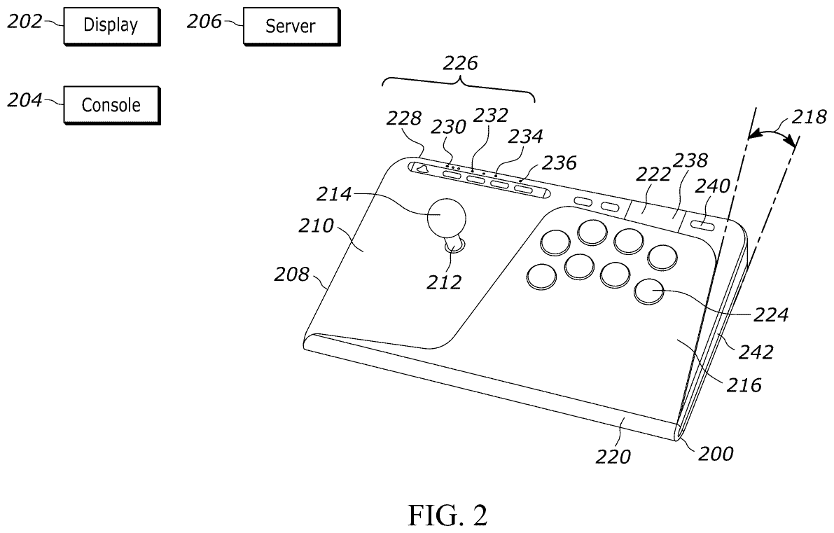

Refer now to FIG. 2. A computer game controller 200 is shown from the top surface in the orientation it would have when held as intended by a player of computer games which may be presented on a display 202 as sourced from, e.g., a computer game console 204 and/or cloud-based game streaming server 206. The controller 200 may be in wired or more preferably wireless communication with one or more of the other devices shown in FIG. 2. In addition to the components discussed further below, the devices 200-206 shown in FIG. 2 may incorporate some or all of the individual components illustrated in FIG. 1, including wireless transceivers, processors, and computer storage devices.

As shown in FIG. 2, the controller 200 includes a generally flat, parallelepiped-shaped base 208 with a flat top surface 210 through which a shaft 212 of a lever extends. The shaft 212 is capped by a grip 214 that extends radially beyond the shaft 212 and that in the example shown is spherical. The grip 214 can be grasped by a player to pivot the lever to thereby generate action signals to control the computer game, such as by causing a player character (PC) to move, and/or shoot a weapon and/or execute hand-to-hand combat moves. The grip 214 may be threadably engaged with the shaft 212 so that it can be removed by hand and a new, differently-sized or configured grip installed.

Continuing the description of FIG. 2, a pad 216 is supported by the base above the top surface 210 of the base 208 and is angled obliquely relative to the top surface 210. In the example shown, an oblique angle 218 is formed between the top surface of pad 216 and top surface 210 of the base 208. In some examples, the oblique angle 218 may be between one degree and twenty degrees, inclusive. In some specific examples, the oblique angle 218 may be between one degree and ten degrees, inclusive. In more specific examples, the oblique angle 218 may be between one degree and five degrees, inclusive. In specific cases, the oblique angle 218 may be between one degree and three degrees, inclusive. In some implementations the oblique angle 218 can be between two degrees and ten degrees, inclusive, and may be between two degrees and five degrees, inclusive.

As shown in FIG. 2, the pad 216 is angled away from the base 208 from a first edge 220 of the base (typically, the edge closest to the player when holding the controller) toward a second, opposite 222 edge of the base (typically, the further edge when held by a player). This provides a comfortable configuration from the player standpoint.

Plural active buttons 224 are radially supported by the pad 216. The active buttons 224 are manipulable to input signals to the computer game such as to control a character such as a PC in a computer game. In the specific embodiment shown, the active buttons 224 are arranged in two arcuate rows. The active buttons 224 are closer to the base's second edge 222 (which the top surface of the pad 216 slopes up toward) than the first edge 220.

As shown in FIG. 2, each row of active buttons 224 includes four buttons for a total of eight buttons. The action buttons 224 are primarily intended to facilitate user inputs for game interactions. In addition, they can also be used for other non-game related inputs as well in certain non-game settings configurations, such as interacting with non-game apps, interfaces with other devices, etc.

In example embodiments the action buttons 224 may include R1 and R2 buttons used for gameplay functions and L1 and L2 buttons also used for gameplay functions. The L1 and R1 buttons may be considered to be shoulder buttons and the L2 and R2 buttons trigger buttons, typically for use in games to shoot a weapon.

The active buttons 224 can also include a PlayStation® Dual Shock®-style circle button, a triangle button, a square button, and an “X” button (or cross button) manipulable to input respective action signals to the computer game.

In a menu (non-game) mode, the cross button may be manipulated to select a highlighted item, the circle button may be manipulated to cancel a command, the triangle button may be manipulated to rearrange the items in a list, or view related information, and the square button may be manipulated to use as a shortcut for context-sensitive commands and to view more functions for a specific item.

In addition to the active buttons 224 on the pad 216, the base 208 may support plural control buttons 226. In the example shown, the control buttons 226 are arranged in a single row, and can be operable to input control signals to one or more of the devices shown in FIG. 2. Like the active buttons 224, the control buttons 226 are closer to the second edge 222 than the first edge 220.

In general, the control buttons 226 are manipulable to access and interact with various features of a game or a user interface (e.g. pause, share, reset, etc.).

Example control buttons from left to right may include a system button 228 which can be pressed once to access a control center. Pressing and holding the system button 228 invokes a game system home screen.

The control buttons 226 may also include a lever mode selector button 230 that can be manipulated to select a mode of operation for using the lever with grip 214. Example lever modes include digital pad (DPAD), right analog stick functionality, and left analog stick functionality. In some examples the mode of lever operation may be defined automatically by the particular game being played.

A lock switch button 232 may be provided to lock out/disable input from the control buttons 226 (and if desired from the additional buttons past the row of control buttons in line with the control buttons and discussed further below). Particularly in the case of tournaments, when an accidental pause of the game occurs because of an unintended push of a control button or other accidental input occurs, a competitive match may be disrupted and a player disqualified who performed the action. The inclusion of the “lock” feature is to help prevent an inadvertent/purposeful manipulation of any “control button” inputs that could disrupt a match in progress. Toggling the lock switch button 232 again can re-enable the control buttons. The active buttons 224 remain enabled regardless of manipulation of the lock switch button 232.

The control buttons 226 may also include a link button 234 to establish wireless communication between the controller 200 and one or more of the other devices shown in FIG. 2. The link button 234 may be toggled to, for example, connect to the console 204, then toggled again to change connection to a personal computer or other component, and then toggled again to switch back to communicating with the console.

Also, the control buttons 226 may include a create button 236 that can be manipulated to display a create menu and take screenshots and video clips.

To the right of the control buttons 226 may be L3 and R3 buttons labeled as such in FIG. 2. These buttons may be used for movement and gameplay functions and may be disabled and enabled if desired along with the control buttons 226. These buttons may be regarded as action buttons in some operational states but they have varied functionality depending on what game is being played. Because the L3/R3 buttons are not primarily or historically used in many arcade/fighting style games, they are not part of the main active button 224 layout.

A touchpad 238 may be in-line with the control buttons 226 to the right of the L3/R3 buttons and may be disabled and enabled along with the control buttons 226 if desired. An options button 240 may be to the right of the touchpad 238 for selecting options.

The control buttons 226 (and if desired other buttons) may be illuminated by lamps such as light emitting diodes (LED) inside the buttons. Also, a light bar 242 can be provided between the base 208 and pad 216 as shown along the edge of the base that extends between the near and far edges 220, 222. The light bar may be illuminated by one or more internal lamps such as LEDs.

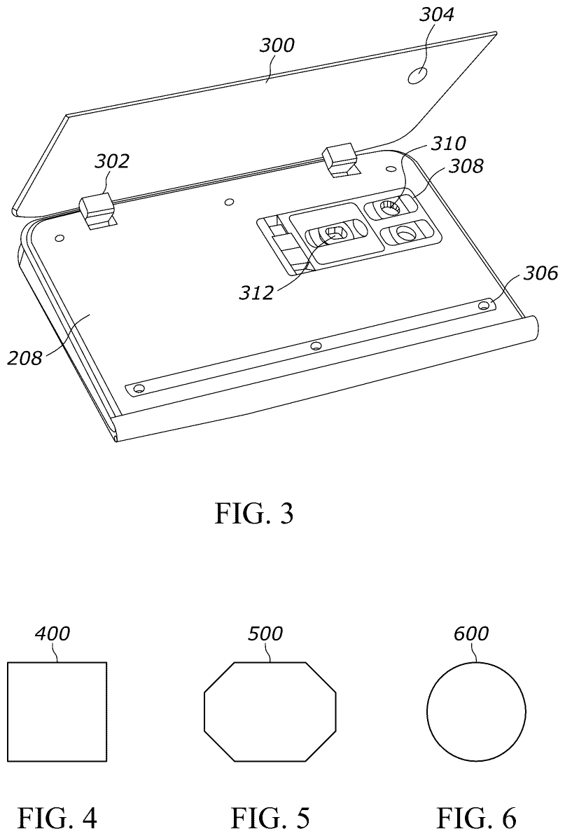

FIG. 3 illustrates the base 208 from the bottom surface opposite the top surface 210 shown in FIG. 2. A cover panel 300 may be hingedly engaged with the base 208 to cover the bottom surface of the base. The cover panel 300 may be coupled to the base 208 at hinges 302 that may be established by soft rubber hinges. One or more magnetic elements 304 on the cover panel 300 may magnetically couple to respective magnetic elements 306 on the base to maintain the cover panel 300 flush against the base in a closed configuration. A magnetic element paid may be established by, e.g., two magnets or a manet and a ferromagnetic plate.

FIG. 3 illustrates that the cover panel 300 may be moved from the closed configuration, in which one or more cavities 308 in the base are covered, to the open configuration shown, to expose the cavities 308. In the example, two cavities 308 are provided each holding a respective spare lever gate 310.

An operational lever gate 212 is also exposed when the cover panel 300 is open. The operational lever gate 312 surrounds the bottom of the shaft 312 shown in FIG. 2 to limit pivotable motion of the lever by confining motion of the bottom of the shaft within the inner periphery of the gate. The cover panel 300 may be opened to swap by hand, without any tools required, the operational lever gate 312 with one of the spare gates 310 by removing both gates from their locations by hand and exchanging them into the other location in an interference or snap fit. In this way, the manner of motion limit for the lever can be changed, because the lever gates shown in FIG. 3 can each have an inner periphery with a different shape than the other lever gates and, thus, that limit movement of the lever differently from the other lever gates.

FIGS. 4-6 illustrate three examples of differently shaped inner peripheries 400, 500, 600 for respective lever gates. The lever gate periphery 400 in FIG. 4 is square. The lever gate periphery 500 in FIG. 5 is octagonal. The lever gate periphery 600 in FIG. 6 is round. Other shapes including triangular and hexagonal are contemplated.

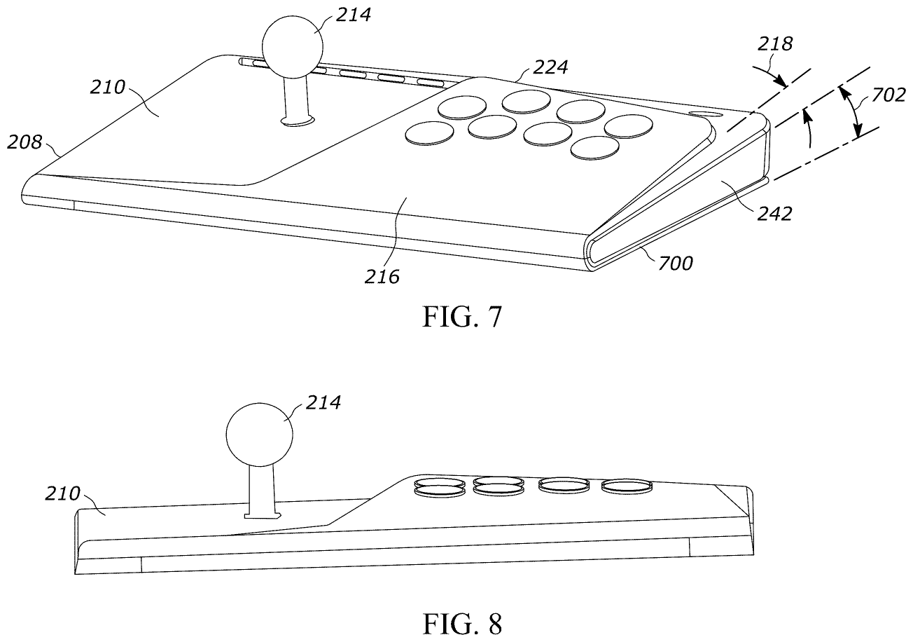

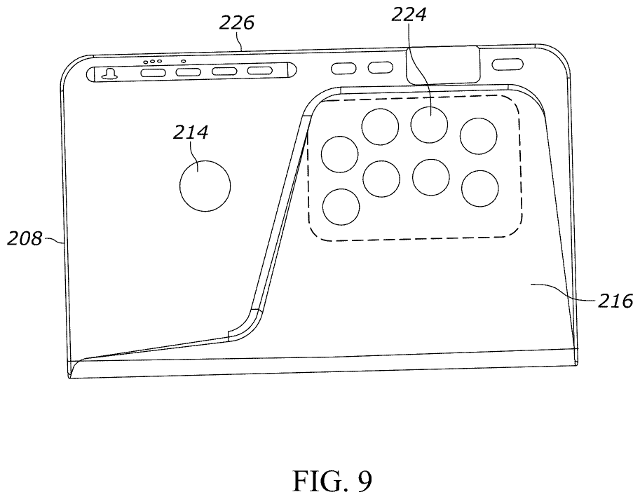

FIGS. 7-9 further illustrate principles described above. As shown best in FIG. 7, the pad 216 is angled obliquely relative to the top surface 210 of the base 208 by the oblique angle 218 formed between the top surface of pad 216 and top surface 210 of the base 208. Moreover, in some examples the top surface 210 of the base 208 may itself be angled obliquely relative to the bottom surface 700 of the controller by an oblique angle 702 resulting in a wedge-shaped light bar 242. Note that the bottom surface 700 of the controller may be the bottom surface of the base 208 or it may be integral to the pad 216, essentially wrapping around from the top of the pad to be flush against and envelop the bottom surface of the base 208.

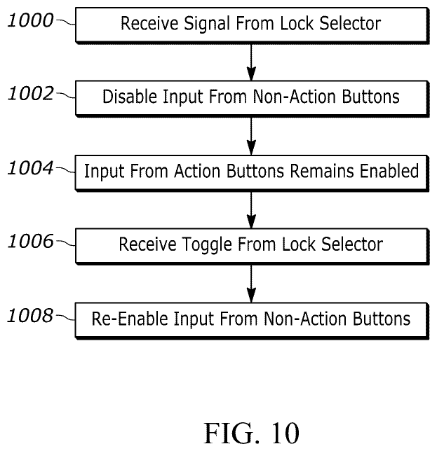

FIG. 10 illustrates example logic for use of the lock switch button 232 shown in FIG. 2. State 1000 indicates that a signal caused by manipulation of the lock switch button is received. is received. Responsive to the signal, the logic moves to state 1002 to disable input from the control (non-action) buttons 226 (excepting the lock switch button 232). If desired, input from the remaining buttons in the same row as the control buttons 226 shown in FIG. 2 also may be disabled. In this way, should a player wielding the controller accidentally brush against or otherwise depress one of the control buttons (excepting the lock switch button 232), no input signal from that mistakenly actuated button will be generated or, if generated, acted upon.

Moving to state 1004, input from the action buttons 224 remains enabled.

Proceeding to state 1006, a second manipulation of the lock switch button 232 generates a signal that at state 1008 re-enables input from the remaining control buttons as well as from any other buttons whose input was disabled a state 1002. Input from the action buttons 224 remains enabled throughout the logic of FIG. 10.

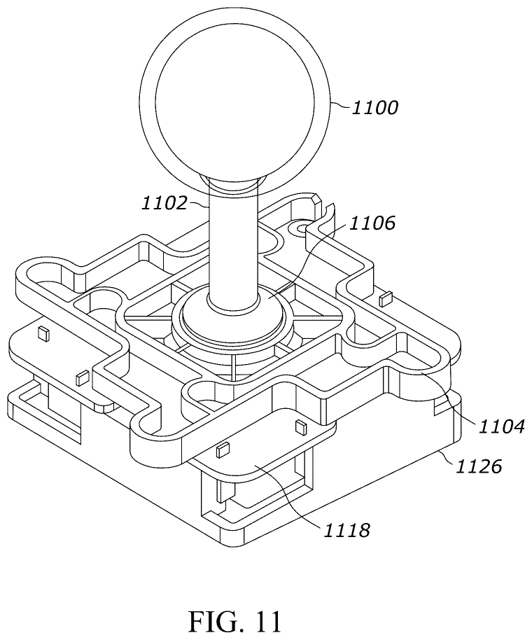

FIGS. 11-13 and 14-16 respectively illustrate digital and analog example implementations of the lever shown in FIGS. 2-7.

Considering first the digital level example in FIGS. 11-13, a grip 1100 is threadably coupled to a shaft 1102 for easy replacement of the grip 1100 with another grip. In the example shown, the grip 1100 is spherical.

The shaft 1102 extends into and through a top plate 1104. More specifically, the shaft 1102 is integrally formed with a collar 1106 that has a curved surface and that can rock in a circular motion (within the constraints imposed by the lever gate described further below) within a socket 1108 of the top plate 1104. Thus, the collar 1106 is movably engaged with the cavity 1108 of the top plate 1104.

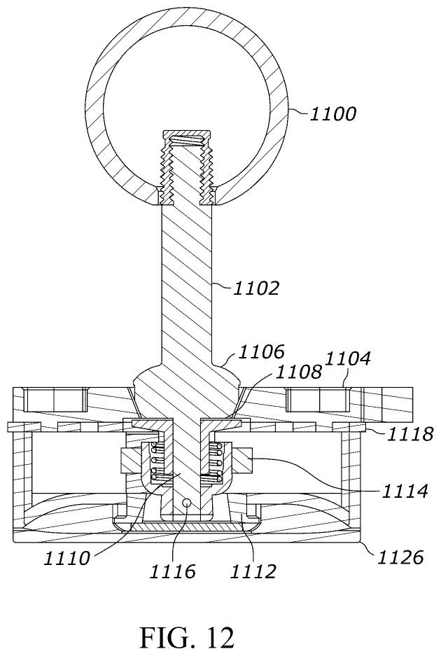

The shaft 1102 also includes a lower segment 1110 that extends down from the collar 1106 into a lever gate 1112, such as any of the lever gates described herein. The lower segment 1110 and collar 1106 are made integrally with each other. Consistent with previous disclosure, the shape of the interior periphery of the lever gate 1112, which is distanced from the lower segment 1110 when the lever is in the neutral position shown in FIG. 12, constrains motion of the lower segment 1110 of the shaft 1102 and, hence, motion of the entire lever.

An actuator 1114 is coupled to the lower segment 1110 of the shaft and snugly surrounds the lower segment so that the actuator moves as the lever moves. In the example and as shown best in FIG. 12, the actuator 1114 is coupled to the shaft by a pin or set screw 1116 extending in the actuator and against or into the lower segment 1110 of the shaft.

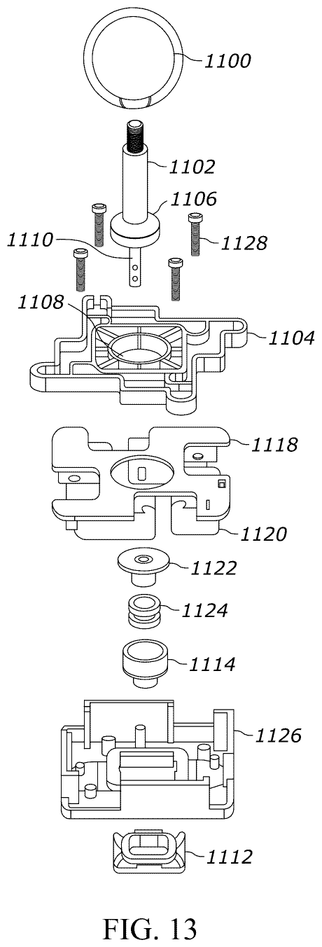

It may now be appreciated that as the lever is moved by a player, the actuator 1114 is moved. A circuit board 1118 is disposed just below the top plate 1104 with the lower segment 1110 of the shaft extending through the circuit board 1118, and plural microswitches 1120 (best shown in FIG. 13) are on the circuit board 1118 and can be contacted by or otherwise actuated by the actuator 1114 when the actuator 1114 is moved in sufficiently close proximity to a microswitch. Thus, each microswitch 1120 is configured to output a respective digital signal when the shaft with actuator is moved against or toward the respective microswitch. The digital signals from the microswitches are sent to a processor as indications of the movement and/or position of the lever.

As can be appreciated looking at FIG. 13, the circuit board 1118 has four support arms bearing respective microswitches, so that each microswitch 1120 is radially spaced relative to the shaft ninety degrees from adjacent microswitches. Thus, the four microswitches may be located at the cardinal coordinates, i.e., north-south-east-west.

Concluding the description of the lever shown in FIGS. 11-13, as best shown in FIG. 13 the lower segment 1110 of the shaft extends through a spring base 1122 that captures a spring 1124 in the actuator 1114 to bias the lever to the neutral position shown in FIG. 12. A bottom plate 1126 mates with the top plate 1104 and is held to the top plate 1104 by threaded fasteners 1128 to enclose the components shown.

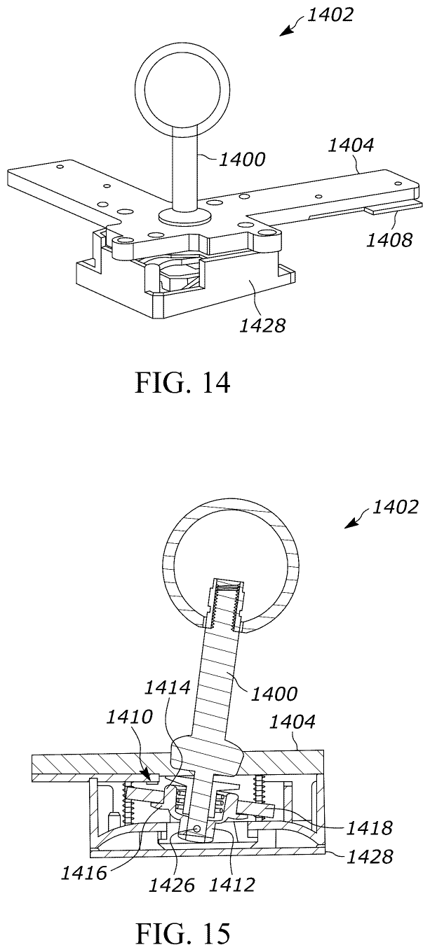

FIGS. 14-16 illustrate a lever that produces analog signals responsive to motion of the lever. It is to be understood that the lever shown in FIGS. 14-16 has substantially the same components as the lever shown in FIGS. 11-13 (some of which may not by illustrated in FIGS. 14-16) with the following exceptions.

A shaft 1400 of a lever 1402 extends through an L-shaped top plate 1404 defining X and Y axes. Respective circuit boards 1406, 1408 are engaged with each arm of the top plate 1404, and on top of or underneath each circuit board 1406, 1408 a respective magnetic sensor 1410 (one sensor 1410 shown in FIG. 15) is engaged. The magnetic sensors may be three dimensional magnetic sensors and may be implemented in some embodiments by Hall effect sensors.

As was the case with the digital lever in FIGS. 11-13, the lower segment of the shat 1400 of the analog lever shown in FIGS. 14-16 is tightly surrounded by an actuator 1412. The actuator 1412 includes a cylinder 1414 and a flange 1416 surrounding the cylinder 1414, and a hollow disk-shaped magnet 1418 surrounds the cylinder 1414 and rests on the flange 1416. The magnet 1418 shown in this example is accordingly a ring magnet that when moved against or toward the magnetics sensor causes the magnetic sensors 1410 to generate analog signals representative of motion of the lever, which signals can be processed and sent to a processor as indications of lever motion/position.

In one example, the magnet 1418 is vertically (parallel to the shaft axis) polarized, and may be made of Neodymium.

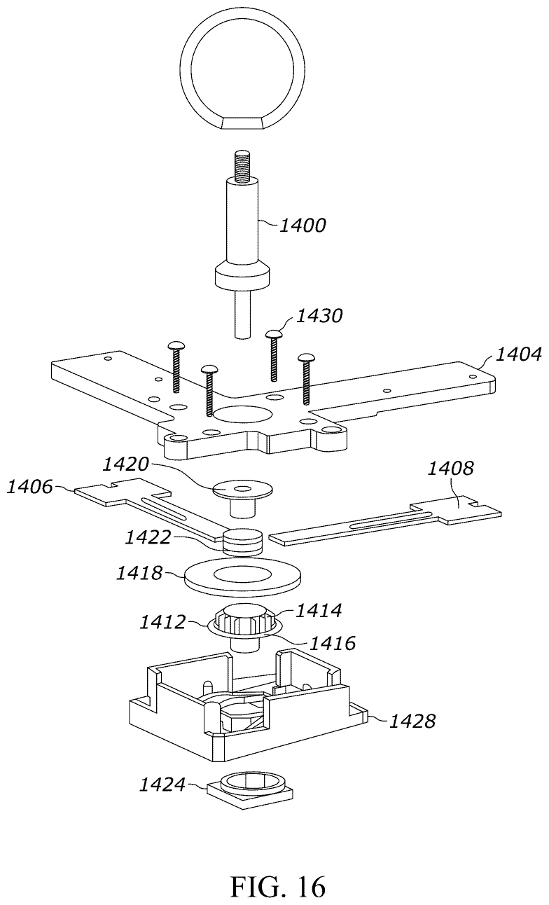

The shaft 1400 also extends through a spring base 1420, spring 1422, and actuator gate 1424 (FIG. 16) which function according to the description of like parts in earlier figures. A set screw or pin 1426 (FIG. 15) couples the actuator 1414 to the shaft 1400. A bottom plate 1428 mates with the top plate 1404 and is held to the top plate 1404 by threaded fasteners 1430 to enclose the components shown.

It may now be appreciated that each magnetic sensor is radially spaced relative to the shaft ninety degrees from adjacent magnetic sensors. Essentially, when two sensors are used and spaced 90 degrees on the arms of the L-shaped top plate, cross-talk between the sensors is limited thereby. The neutral (upright) position of the lever can be on the zero signal point for both magnetic sensors.

Alternatively, a single magnetic sensor may be used below the manet.

If desired, an optical encoder may be used between the top and bottom plates to sense rotation of the shaft in addition to the magnetic sensors sensing motion of the shaft caused by pivoting the lever. A z-axis motion sensor may also be provided between the top and bottom plates.

Also, if desired a temperature sensor may be provided between the top and bottom plates and its temperature signal used to normalize the signals from the magnetic sensors for temperature variations.

Analog lever calibration may be effected to transform 2D raw vector data from the magnetic sensors to a circle. Background auto calibration can be executed to correct for other forms of drift (e.g., mechanical movement).

While the particular embodiments are herein shown and described in detail, it is to be understood that the subject matter which is encompassed by the present invention is limited only by the claims.

1. An apparatus comprising:
a base comprising a top surface and a cavity;
a plurality of active buttons arranged in two arcuate rows and juxtaposed with the top surface of the base, at least some of the active buttons being manipulable to control a character in a computer game;
a plurality of control buttons supported by the base and arranged in a single row, at least some of the control buttons being operable to input control signals to the apparatus;
a lever extending through the top surface of the base and manipulable to input signals to the computer game;
a first gate disposed entirely below the top surface to limit pivotable motion of the lever in a first way; and
a second gate disposed in the cavity and swappable by hand with the first gate to limit pivotable motion of the lever in a second way.

2. The apparatus of claim 1, wherein the lever comprises;
a shaft extending through the top surface of the base, the shaft comprising a top end disposed above the top surface and an opposite, bottom end disposed below the top surface; and
a grip coupled to the top end of the shaft;
wherein at least a portion of the bottom end of the shaft is disposed within a periphery of the first gate.

3. The apparatus of claim 2, wherein the second gate comprises a periphery that is configured to receive the portion of the bottom end of the shaft, the periphery of the second gate comprising a different shape than a shape of the periphery of the first gate,
wherein the second gate is configured to replace the first gate.

4-8. (canceled)

9. The apparatus of claim 1, comprising at least a third gate removably disposed in the cavity in the base and swappable by hand with the first gate to limit pivotable motion of the lever in a third way.

10-20. (canceled)

21. The apparatus of claim 2, wherein the cavity extends through a bottom surface of the base and comprises a first compartment and a second compartment, wherein the first compartment at least partially surrounds the bottom end of the shaft;
wherein the first compartment is configured for selectively receiving one of the first gate or the second gate, and
wherein the second compartment is configured to store the other of the first gate or the second gate.

22. The apparatus of claim 21, comprising a bottom cover coupled to the base and movable between an open position, in which the first and second compartments of the cavity are exposed, and a closed position, in which the first and second compartments of the cavity are covered.

23. The apparatus of claim 2, wherein the shaft comprises a collar between the top end and the bottom end, the collar having a diameter greater than a diameter of the top end and greater than a diameter of the bottom end.

24. The apparatus of claim 23, wherein the lever comprises:
a top plate with an aperture sized to receive the collar of the shaft;
a bottom plate coupled to the top plate; and
an actuator assembly disposed between the top plate and the bottom plate and coupled to the shaft below the collar,
wherein the actuator assembly is configured to receive input from movement of the shaft and activate one or more switches of a circuit board disposed in the base.

25. A game controller comprising:
a base comprising a top surface, a bottom surface, and a cavity extending through the bottom surface;
a lever assembly coupled to the base and comprising a shaft extending through the top surface, the shaft comprising a first end disposed above the top surface and a second end disposed entirely below the top surface;
a plurality of buttons accessible through the top surface and operable to input control signals; and
a lever gate removably received in the cavity of the base and accessible from the bottom surface, wherein the lever gate comprises a shape that is configured to limit pivotable motion of the lever assembly when engaging with the second end of the shaft.

26. The game controller of claim 25, wherein the cavity comprises:
a first compartment disposed directly below the shaft of the lever assembly, the first compartment being configured for selectively receiving the lever gate to couple the lever gate to the lever assembly; and
a second compartment configured for storing the lever gate.

27. The game controller of claim 26, comprising a bottom cover coupled to the base and movable between an open position, in which the first and second compartments of the cavity are exposed, and a closed position, in which the first and second compartments of the cavity are covered.

28. The game controller of claim 25, wherein the shaft comprises a collar between the first end and the second end, the collar having a diameter that is greater than a diameter of the first end and that is greater than a diameter of the second end.

29. The game controller of claim 28, wherein the lever assembly comprises:
a top plate comprising an aperture sized to receive the collar of the shaft;
a bottom plate coupled to the top plate; and
an actuator assembly disposed between the top plate and the bottom plate and coupled to the shaft below the collar,
wherein the actuator assembly is configured to receive input from the lever assembly and activate one or more switches of a circuit board disposed in the base.

30. The game controller of claim 26, comprising a second gate having an opening sized to receive the second end of the shaft and comprising a shape that is configured to limit pivotable motion of the lever assembly when the second end of the shaft engages with the second gate,
wherein the shape of the opening of the second gate is different than the shape of the opening of the lever gate, and
wherein the second gate is configured to be received by the first compartment of the cavity.

31. The game controller of claim 30, comprising a third gate having an opening sized to receive the second end of the shaft and comprising a shape that is configured to limit pivotable motion of the lever assembly when the second end of the shaft engages with the third gate,
wherein the shape of the opening of the third gate is different than the shape of the opening of the lever gate and different than the shape of the opening of the second gate,
wherein the third gate is configured to be received by the first compartment.

32. The game controller of claim 31, wherein the cavity comprises a third compartment configured for storing the lever gate.

33. A method of adjusting a joystick assembly of a game controller, the method comprising:
locating a first lever gate from a bottom surface of a base of a controller, wherein the controller comprises a lever assembly coupled to the base and comprising a shaft extending through a top surface of the base, the shaft comprising a first end disposed above the top surface and a second end disposed below the top surface, wherein the first lever gate comprises an opening that is configured to limit pivotable motion of the lever assembly when the first lever gate engages the second end of the shaft;
removing the first lever gate from a cavity of the base, wherein the cavity extends through the bottom surface of the base;
inserting, from the bottom surface of the base, a second lever gate into the cavity, wherein the second lever gate comprises an opening that has a different shape than the opening of the first lever gate and is configured to limit pivotable motion of the lever assembly when the second lever gate engages the second end of the shaft.

34. The method of claim 33, wherein removing the first lever gate comprises removing the first lever gate from a first compartment of the cavity, wherein the first compartment is directly below, and at least partially surrounds, the second end of the shaft.

35. The method of claim 34, comprising inserting, from the bottom surface of the controller, the first lever gate into a second compartment of the cavity, wherein the second compartment of the cavity is sized to receive the first lever gate or the second lever gate.

36. The method of claim 35, comprising removing the second lever gate from a second compartment of the cavity before inserting the second lever gate into the first compartment of the cavity.
